(19) United States
(12) Patent Application Publication
(10) Pub. No.: US 2012/0145532 A1
(43) Pub. Date: Jun. 14, 2012

(54) Efficient hydrogen production by photocatalytic water splitting using surface plasmons in hybrid nanoparticles

(75) Inventors: Gennady A. Smolyakov, Albuquerque, NM (US); Marek A. Osinski, Albuquerque, MN (US)

(73) Assignee: STC.UNM

(21) Appl. No.: 13/374,364

(22) Filed: Dec. 23, 2011

Related U.S. Application Data
(63) Continuation of application No. PCT/US10/02049, filed on Jul. 21, 2010.
(60) Provisional application No. 61/271,686, filed on Jul. 24, 2009.
(60) Provisional application No. 61/340,119, filed on Mar. 12, 2010.

(51) Int. Cl. C01B 3/02; B01J 23/50; B01J 23/52; B01J 23/42; B01J 23/89; B01J 21/06; B01J 23/20; B01J 27/04; B01J 19/12; B01J 35/02; B01J 23/44; B82Y 30/00

(52) U.S. Cl. 204/157.44; 502/1; 204/157.52; 977/773

(57) ABSTRACT

Photocatalytic water splitting is employed as a method to directly obtain clean hydrogen from solar radiation by using hybrid nanoparticles with metallic cores and semiconductor photocatalytic shells. Efficient unassisted overall photocatalytic splitting of water is based on resonant absorption from surface plasmon in metal core/semiconductor shell hybrid nanoparticles, which can extend the absorption spectra further towards the visible-near infrared range, thus dramatically increasing the solar energy conversion efficiency. When used in combination with scintillator nanoparticles, the hybrid photocatalytic nanoparticles can be used for conversion of nuclear energy into hydrogen.

### RELATED APPLICATIONS

This application claims benefits and priority of U.S. provisional application Ser. No. 61/271,686 filed Jul. 24, 2009, and U.S. provisional application Ser. No. 61/340,119 filed Mar. 12, 2010, the disclosures of which are incorporated herein by reference.

### FIELD OF THE INVENTION

The invention relates to photocatalytic splitting of water using light energy impinging on photocatalytic nanoparticles, and to photocatalytic hybrid nanoparticles comprising a metal core and a semiconductor shell on the core.

### BACKGROUND OF THE INVENTION

### Photoelectrochemical Splitting of Water:

Increasing energy demand and growing environmental concerns drive the search for renewable sources of energy to replace the fast depleting fossil fuel energy sources. Since the only way to store large amounts of energy is in the form of a chemical energy carrier, hydrogen is considered as one of the primary candidates for future energy storage. The future prospect of hydrogen economy is mainly in the direct conversion of solar energy into hydrogen by means of photo-electrochemical devices (PEC cells) for water splitting.

The overall efficiency of such a device would be determined by the basic working principles and properties of photoactive materials. The tremendous progress made in the field of nanostructured materials provides new exciting opportunities for water splitting.

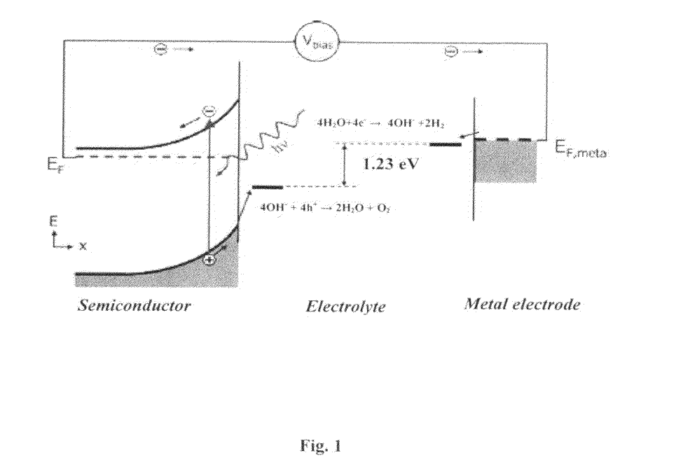

The principle of operation of a PEC cell is illustrated in the energy diagram of FIG. 1. When the semiconductor material is illuminated with photons of energy larger than the bandgap, electrons are excited from the valence band into the conduction band. The excited electrons travel to the back contact and are transported to the counter electrode where they reduce water and form hydrogen gas. The holes that remain in the valence band migrate to the surface, where they oxidize water and form oxygen gas. The recombination of electrons and holes is prevented by an applied bias and by electric field appearing during the formation of a Schottky-type contact between the semiconductor material and the aqueous electrolyte (shown by a “bending” of the energy bands).

Photoelectric materials for efficient hydrogen generation have to meet the following requirements: (1) strong UV/visible light absorption; (2) high chemical stability in the dark and under illumination; (3) suitable band edge alignment to enable reduction/oxidation of water; (4) efficient charge transport in the semiconductor; and (5) low overpotentials for the reduction/oxidation reactions.

Despite the extensive research effort, no photoactive material has yet been found to meet all these requirements. The stability against (photo)corrosion is a severe requirement that limits the usefulness of many photoactive materials. The general trend is that wide-bandgap metal oxide semiconductors are stable against (photo)corrosion, while small bandgap semiconductors are not. For example, TiO₂ (bandgap of 3.2 eV) is known for excellent stability over a wide range of pH values and applied potentials. The requirement of proper band edge alignment implies that the reduction and oxidation potentials of water should be inside the bandgap of the semiconductor material, that is E_{c} should be above E_{red}(H₂/H⁺) and Eᵣ should be below Eₒₓ(OH⁻/O₂). Most semiconductor materials, however, do not meet this requirement. Most non-oxide semiconductors are able to reduce, but not oxidize water, and on the other hand most oxide semiconductors are able to oxidize, but not reduce water [van de Krol 2008]. Since metal oxide semiconductors are favored by the stability requirement, the reduction of water appears to be a challenge. Very few metal oxides, indeed, have been demonstrated to evolve both oxygen and hydrogen, and only SrTiO₃ has been shown to photo-split water in a two-electrode system without any assistance [Mavroides 1976]. An externally applied voltage or a separate electrode compartment with a different pH is often necessary to assist the reduction reaction. Inefficient charge transport in some materials is often the main cause of poor overall conversion efficiencies. For example, poor hole transport limits the photoresponse of Fe₂O₃ photoanodes.

TiO₂ is by far the most widely investigated material due to its ready availability, low cost, lack of toxicity, and photostability. However, with the large band gap of 3.2 eV of TiO₂, only a small UV fraction (˜2-3% of the solar spectrum) can be utilized. Significant research effort is aimed at sensitization of TiO₂ by shifting the optical absorption towards the visible part of the spectrum via doping. These attempts, however, have met with limited success. Regardless of whether anion or cation dopants are used, the recombination centers they introduce are difficult (if not impossible) to avoid when doping wide-bandgap semiconductors.

Water Splitting with Nanosized Photocatalysts:

The tremendous progress made in the field of nanostructured materials provides new exciting opportunities for water splitting. As distinct from bulk photocatalysts, realized as thin films on conducting substrates, water splitting with nanosized photocatalysts simply utilizes a photocatalyst powder dispersed in water. The principles of photocatalytic water splitting require high surface areas for electron excitation and collection, and the use of nanocatalysts with their high surface to volume ratio is a perfect match. The reduction and oxidation reactions both have to take place at the surface of a single particle, and hydrogen and oxygen, produced in the same reactor volume, need to be separated immediately afterwards. Nanosized semiconductors can revolutionize the field of photocatalysis through the combined effects of quantum confinement and their unique surface morphologies. As a result of quantum confinement, materials that are not suitable for this application in bulk form due to insufficiently energetic electrons or holes can be utilized on nanoscale. With significant blue-shift in nanosized catalysts, direct reduction of water may become feasible without the need for an additional external bias. Nanosized materials have an increased surface to volume ratio and are very sensitive to surface effects. Surface modification of nanosized catalysts will affect redox potentials, and can be used to enhance the efficiency of charge transfer and charge separation. Also, the problem of poor carrier transport in some bulk materials can be significantly alleviated on nanoscale, as the distance the photogenerated carriers have to travel to reach the surface is radically decreased. For example, poor hole transport in Fe₂O₃ was overcome in an optimized morphology with high aspect ratio nanowire electrodes, whose diameter was smaller than the hole diffusion length in Fe₂O₃ [Dare Edwards 1983].

The photocatalytic processes with TiO₂ and other nanosized semiconductors, however, have revealed that only a small fraction of the photoexcited charge carriers can be utilized to induce redox processes at the interface because of the high recombination rate and the small size of particles comparable to the width of the space-charge layer that would normally form at the bulk semiconductor-electrolyte interface. While the built-in potential of such a layer promotes charge separation in case of bulk semiconductor-electrolyte interface, for small particles of ˜10 nm radius usually the entire particle is depleted and the very small potential drop at the center of the particle cannot assist in the separation of electron-hole pairs. Improvement in efficiency of charge separation is possible in semiconductor-semiconductor or semiconductor-metal composite nanoparticles (NPs). For example, a deposition of noble metals such as Au, Ag, Pt, or Pd on semiconductor NPs is known to enhance their photocatalytic activity [Subramanian 2004]. The noble metal acts as a reservoir for photogenerated electrons and promotes an interfacial charge-transfer process [Jakob 2003], [Subramanian 2004].

### Surface Plasmons in Noble Metal and Hybrid Nanoparticles:

The good electron-storing properties of noble metal nanoparticles and their ability to act as electron transfer sites in nanostructures have been proven by electrochemical studies [Hirakawa 2005]. Much less attention has been paid to photoinduced electron transfer from noble metal nanoparticles to semiconductors. This reaction offers an exciting prospect of effective utilization of the entire spectrum of solar energy based on the strong plasmon absorption bands of noble metal nanoparticles.

Noble metal NPs are known to have unique optical properties due to the excitation of resonant collective oscillations of the conduction electrons by electromagnetic radiation—the localized surface plasmon resonance (LSPR). A strong electromagnetic field generated by the free electron oscillation near the metal surface can interact with molecules in the field and cause unique enhancement of optical processes, such as fluorescence, Raman scattering, and absorption. Once excited, a surface plasmon can decay radiatively by re-emission of a photon (scattering), or nonradiatively (absorption) via electron-hole pair formation. When compared with molecular species such as chromophores, the absorption and scattering cross sections of gold and silver NPs are 5-6 orders in magnitude higher. Since one of the decay paths of the plasmons leads to generation of “hot” electron-hole pairs, the noble metal NPs, when excited within their LSPR absorption bands, can be used as efficient catalysts promoting chemical reactions on their surfaces pursuant to the invention. The wavelength at which noble metal NPs resonantly absorb and scatter light can be precisely controlled by changing their shapes and dimensions [Link 1999]. For example, the densities of free electrons in gold and silver are in the proper range to produce NP LSPR peaks in the visible part of the optical spectrum. For spherical gold and silver particles of 1-20 nm in diameters, only dipole plasmon resonance is involved, and their suspensions display a strong LSPR peak around 510 nm and 400 nm, respectively. The peak position of LSPR of spherical gold NPs was found to be weakly size-dependent (˜570 nm peak position for particles ˜100 nm in diameter) [Link 1999]. For gold nanorods, the plasmon absorption splits into two bands, corresponding to the oscillation of the free electrons along and perpendicular to the long axis of the rods. The transverse mode shows a resonance at about 520 nm, which is coincident with the plasmon band of spherical particles, whereas the resonance of the longitudinal mode is red-shifted and strongly depends on the nanorod aspect ratio R. LSPR absorption peaks extending to NIR (up to 800 nm) have been demonstrated in gold nanorods with R˜4 [Link 1999]. Pt and Pd nanodisks of various aspect ratios have recently been shown to support LSPRs over a wide spectral range (UV-Vis-NIR), with the nonradiative decay (absorption) channel dominating for particles with diameter ≦530 nm [Langhammer 2006], which makes them very promising candidates for plasmon-mediated chemistry.

A direct evidence of plasmon-induced electron transfer from noble metal nanoparticles to semiconductors has been provided by using a femtosecond time-resolved infrared probe technique in experiments with 10-nm gold nanoparticles adsorbed onto TiO₂ nanoparticles of different diameter (9 nm-50 nm) [Furube 2007], [Du 2009]. For all of the gold—TiO₂ systems, fast electron injection (<50 fs) from the gold nanoparticle to the conduction band of TiO₂ was directly observed after optical excitation of the surface plasmon band of gold nanoparticles at 550 nm. Electron injection yield reached 20-50%, and the charge recombination decay was observed with the lifetime of 10-100 ps strongly dependent on the diameter of TiO₂ particle.

In most of the photocatalytic studies, noble metals have been either deposited as NPs on the surface of semiconductor films, or loaded on the surface of semiconductor NPs as small metal islands to facilitate charge separation by storing the photogenerated electrons and to promote interfacial electron transfer at the electrolyte interface. Corrosion or dissolution of noble metal particles in the course of a photocatalytic reaction is very likely to limit the practical application of such systems. A better synthetic design is to employ the metal as a core and the semiconductor photocatalyst as a shell of a composite NP. Photocatalytic properties of Ag core/TiO₂ shell composite NPs have been studied in [Hirakawa 2005]. Electrons generated in the TiO₂ shells under UV excitation were stored in the Ag cores and then discharged upon exposure to an electron acceptor. No attempt has been made, however, to explore the plasmon-induced electron transfer from the Ag core to the TiO₂ shell and its effect on the photocatalytic properties of the TiO₂ shell. The very first such an attempt has been made in [Chuang 2009], where Ag core/TiO₂ shell NPs have been demonstrated to possess significantly higher photocatalytic activities than TiO₂ NPs in the visible light region, which was ascribed to the excitation of photogenerated electrons from the surface of Ag cores to the conduction band of TiO₂ shell and their further diffusion to the surroundings. It should be pointed out that the mechanisms of photocatalytic activity of Ag/TiO₂ NPs have been studied in UV and Vis regions separately, and not a single study has been published on photocatalytic activity from any metal core/semiconductor photocatalyst shell NPs under simultaneous irradiation by UV and visible light.

### SUMMARY OF THE INVENTION

The present invention involves in an embodiment use of wide-spectrum excitation of noble metal core/semiconductor shell hybrid nanoparticles for unassisted photocatalytic splitting of water. For example, an embodiment of the invention is based on systems using the energy of the entire solar spectrum for overall unassisted photocatalytic splitting of water using noble metal core unique plasmonic properties that provide photoinduced electron transfer from the noble metal core to a semiconductor shell or layer thereon. A method is provided for overall photocatalytic splitting of water using metal core/semiconductor shell composite nanoparticles where a noble metal (e.g. Au, Ag, Pt, Pd, or noble metal alloy) core is coated with a wide-bandgap semiconductor photocatalyst (e.g. TiO₂, ZnS, Nb₂O₅) transparent to optical excitation in the visible and near-infrared (NIR) spectral ranges, consistent with plasmon absorption bands of the metal core.

Another embodiment of the present invention involves nuclear irradiation of scintillator nanoparticles that in turn generate UV and visible light that irradiates photocatalytic nanoparticles of the type described above to generate electron-hole pairs both in the core and the shell of the composite nanoparticle. Radiation from nuclear waste (e.g. spent fuel) or nuclear reactor can be employed to irradiate the nanoscintillators, which function as sources of UV and visible light in this embodiment of the invention. Colloidal scintillator nanoparticles and colloidal photocatalytic nanoparticles can be employed in a water co-dispersion to this end.

Other advantages of the present invention will become apparent from the following detailed description taken with the following drawings.

### BRIEF DESCRIPTION OF THE INVENTION

FIG. 1 illustrates and energy diagram of a PEC cell based on an n-type semiconducting photoanode.

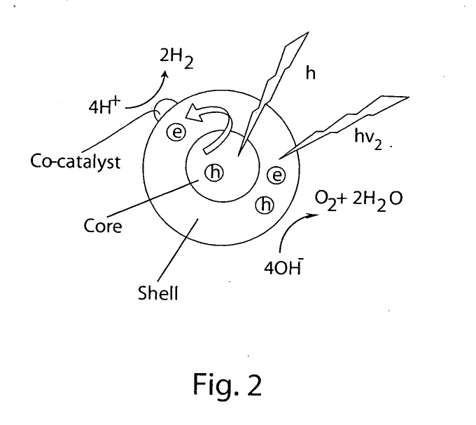

FIG. 2 schematically illustrates practice of the invention using a metal core-semiconductor shell nanoparticle for light energy conversion.

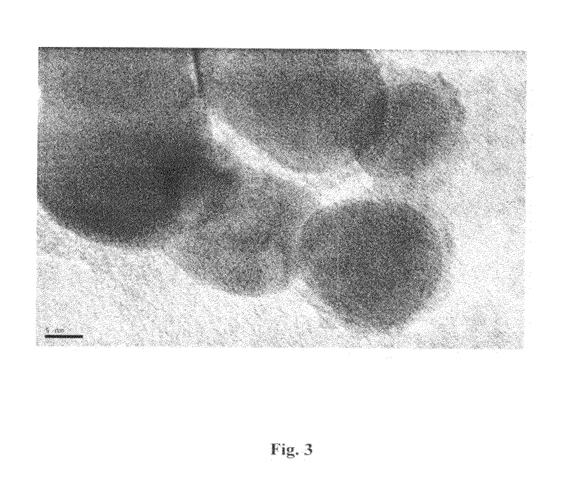

FIG. 3 is a bright-field image TEM (transmission electron microscope) image of Ag/TiO₂ nanoparticles.

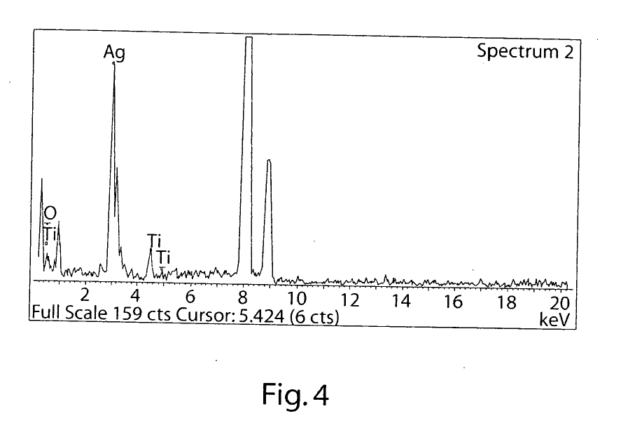

FIG. 4 shows an EDS (energy dispersive spectroscopy) spectrum that confirms the presence of both silver and titanium dioxide in the synthesized hydrib nanoparticles.

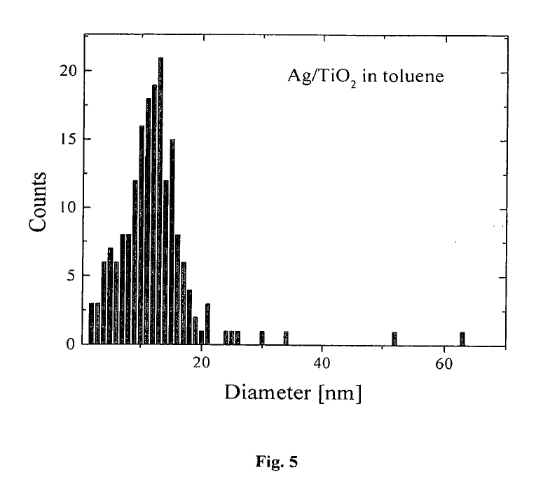

FIG. 5 shows a DLS (dynamic light scattering) particle analysis performed on Ag/TiO₂ NP dispersion in toluene revealing the hydrodynamic size distribution with a maximum size around 13 nm.

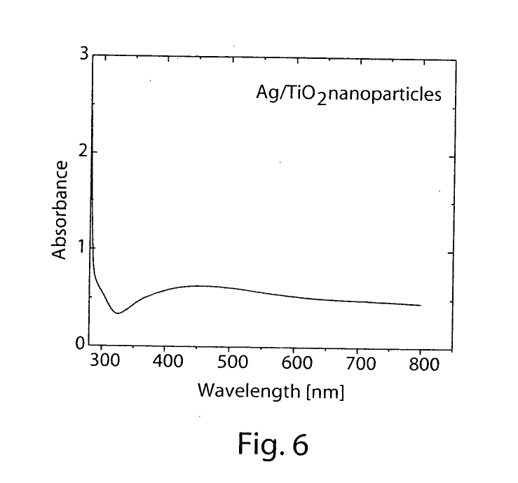

FIG. 6 shows the absorption spectrum for a Ag/TiO₂ colloidal solution having a broad LSPR-related absorptioin band in the visible-NIR region with maximum around 450 nm.

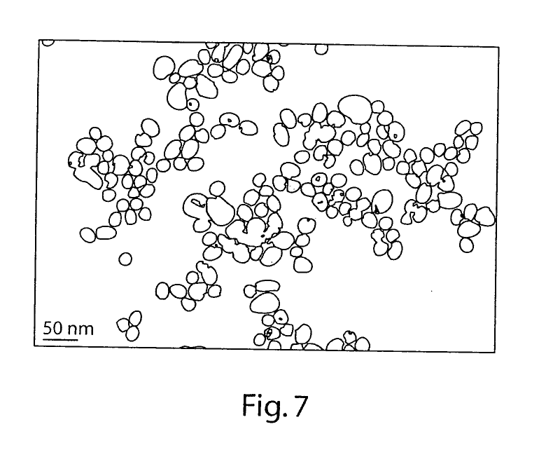

FIG. 7 is bright-field TEM image of Au nanoparticles.

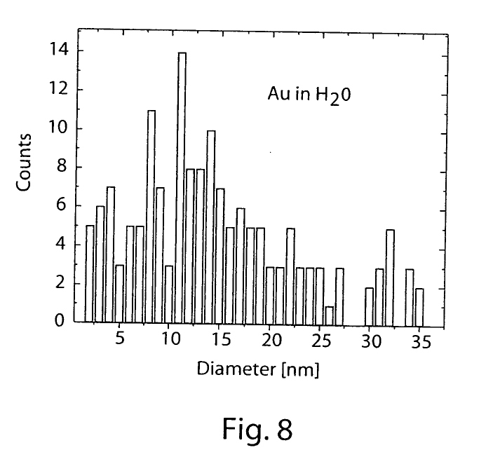

FIG. 8 is a DLS analysis performed on Au NP dispersion in toluene revealing the hydrodynamic size distribution with a maximum size around 11 nm.

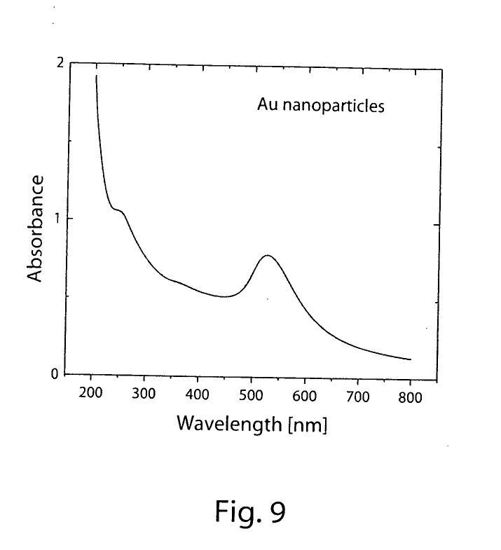

FIG. 9 shows the absorption spectrum for a Au colloidal disperison having LSPR-related absorption in the visible region with a maximum around 530 nm.

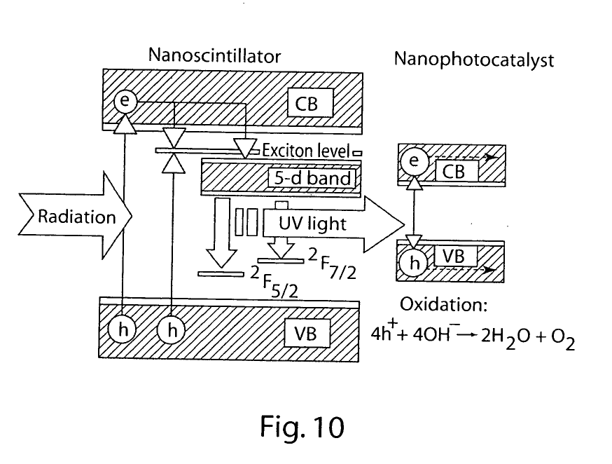

FIG. 10 schematically illustrates practice of the invention using nanoscintillators in combination with photocatalytic nanoparticles for direct use of nuclear radiation to produce hydrogen wherein the irradiated nanoscintillators function as sources of UV and visible light that impinges on the photocatalytic nanoparticles. Half reaction of oxidation of water is illustrated.

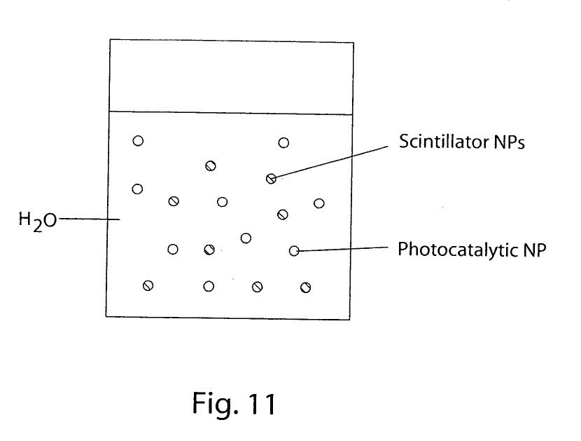

FIG. 11 illustrates a co-dispersion of nanoscintillator particles and photocatalytic nanoparticles in water pursuant to an embodiment of the invention.

### DESCRIPTION OF THE INVENTION

One embodiment of the present invention involves full solar spectrum irradiation of the noble metal core/semiconductor shell hybrid nanoparticles to generate electron-hole pairs both in the core and the shell of composite (hybrid) nanoparticles. This embodiment of the invention is based on systems using the energy of the entire solar spectrum for overall unassisted photocatalytic splitting of water using noble metal core unique plasmonic properties that provide photoinduced electron transfer from the noble metal core to a semiconductor shell or layer thereon. The method is provided for overall photocatalytic splitting of water using metal core/semiconductor shell composite nanoparticles where a noble metal (e.g. Au, Ag, Pt, Pd or noble metal alloy) core is coated with a wide-bandgap semiconductor photocatalyst (e.g. TiO₂, ZnS, Nb₂O₅) shell or layer transparent to optical excitation in the visible and near-infrared spectral ranges, consistent with plasmon absorption bands of the metal core as illustrated on FIG. 2. The noble metal core can comprise Au, Ag, Pt, Pd, an alloy of two or more of Au, Ag, Pt, and Pd, or an alloy of one or more these noble metals with Ni. The noble metal core can have different shapes and sizes. For purposes of illustration and not limitation, the noble metal core can have various shapes including, but not limited to, spheres, disks and rods. The noble metal core can have various sizes (at least one dimension) within the range of 1 nm to 100 nm. The wide-bandgap semiconductor photocatalyst is selected from the group consisting of TiO₂, ZnS, Nb₂O₅ shell or layer, which can have a thickness in the range of 1 nm to 10 nm, for purposes of illustration and not limitation.

Under full solar spectrum irradiation, electron-hole pairs will be generated both in the core and the shell of the composite nanoparticle. Holes photogenerated in the shell by the UV portion of the optical excitation will oxidize water, whereas plasmon-induced transfer of energetic electrons from the metal core to the semiconductor shell is expected to enhance the catalytic activity of the shell photocatalyst for reduction of water. Small amounts of co-catalysts, such as RuO₂ in the case of TiO₂ shell, can be deposited onto the shell photocatalyst's surface in order to enhance the kinetics and avoid recombination of H₂ and O₂ by spatially separating sites for H₂ and O₂ to evolve. The system is also designed to optimize dynamics of charge recombination on the metal core and in the shell material. Because of the possible formation of Schottky barrier at the metal core—semiconductor shell interface, the photogenerated electrons from TiO₂ shells are expected to transfer to metal cores rapidly. The metal core might become an effective center for recombination of the holes photogenerated in the core under Vis portion of the optical excitation with the electrons from the shell photogenerated under UV excitation, thus maintaining the overall electric charge balance of the water splitting reaction. Rather broad plasmon absorption bands of the metal core, tunable over a wide (visible through near infrared) spectral range, may allow for greatly enhanced efficiency of solar hydrogen production by utilizing the entire solar spectrum with metal core-semiconductor shell composite nanoparticles of various sizes and shapes made within a single material system and co-dispersed in water. Alternatively, hybrid nanoparticles with various noble-metal cores can be mixed to provide additional flexibility in covering a wide spectral range for absorption.

The hybrid nanoparticles can be fabricated using colloidal synthesis approach, used previously by the inventors for a variety of nanocrystals, such as CdSe/ZnS, ZnO, LaBr₃/LaF₃, Fe₂O₃, InP, etc. An illustrative colloidal synthesis procedure for making hybrid Ag/TiO₂ core-shell nanoparticles (particles having 1 nm to 100 nm diameter) is a modification of Ag/TiO₂ synthesis reported in [Hirakawa 2005] that involves reduction of metal ions and hydrolysis of titanium (triethanolaminato)-isopropoxide (TTEAIP) in dimethylformamide (DMF). During a typical synthesis procedure, 4 mL of 15 mM aqueous AgNO₃ solution was mixed with 36 mL of 8.3 mM solution of TTEAIP stock solution in isopropanol. 20 mL of DMF was then added into TTEAIP-Ag solution. The solution was stirred first for 15 min at room temperature and then refluxed with continuing stirring. With continuing heating of the solution, the color of the solution slowly changed from colorless to light brown. After 90 min, the color of the suspension turned to dark brown. At that point, the heating was stopped and the suspension was stirred until it cooled down to room temperature. The suspension of Ag/TiO₂ was centrifuged for 5 min at 8000 rpm and resuspended in ethanol solution. The centrifugation procedure was repeated 3 times to minimize the content of water and DMF in the suspension. [Hirakawa 2005—T. Hirakawa, P. V. Kamat, “Charge separation and catalytic activity of Ag@TiO₂ core-shell composite clusters under UV-irradiation”, J. Am. Chem. Soc. 127(#11), pp. 3928-3934, 2005, incorporated herein by reference].

The bright-field image TEM image of Ag/TiO₂ NPs is presented in FIG. 3. The EDS analysis confirms the presence of both silver (3 keV peak) and titanium dioxide (the remaining labelled peaks) in the synthesized hybrid NPs, FIG. 4. The DLS analysis performed on Ag/TiO₂ nanoparticle dispersion in toluene revealed the hydrodynamic size distribution with a maximum size around 13 nm, FIG. 5. The Ag/TiO₂ colloidal dispersion shows a broad LSPR-related absorption band in the visible-NIR region with maximum around 450 nm, FIG. 6.

In addition to silver core nanoparticles, the invention envisions using other noble metal core nanoparticles with suitable plasmon properties such as including, but not limited to, Au, Ag, Pt, and Pd and alloys thereof with one another and other metals. For purposes of illustration and not limitation, water-dispersible gold NPs were synthesized using a classical one-pot approach of [Turkevich 1951] as presented in [Reddy 2007], which involves reduction of a gold hydrochlorate (HAuCl₄.3H₂O) solution with sodium citrate in water. Details of the synthesis are as follows:

During a typical synthesis procedure, 1 mL of 5 mM gold(III) chloride trihydrate solution was diluted with 18 mL water and brought to a boil. 1 mL of 17 mM sodium citrate solution was then added and the solution underwent continued heating until a coffee color was observed. The solution was then stirred for 15 minutes and allowed to cool to room temperature, resulting in 0.25 mM concentration of gold nanoparticles.

FIG. 7 shows a bright-field TEM image of the synthesized Au nanoparticles. EDS analysis confirmed the presence of gold in the synthesized NPs. FIG. 8 shows the DLS analysis performed on the the Au NP dispersion and a rather wide hydrodynamic size distribution, peaked at around approximately 11 nm diameter. The Au NP dispersion showed significant LSPR-related absorption in the visble light region with a maximum around 530 nm, FIG. 9. Hybrid Au/TiO₂ photocatalystic nanoparticles can be made in the manner similar to that described for AW/TiO₂ photocatalystic nanoparticles.

Another embodiment of the present invention illustrated in FIGS. 10 and 11 involves nuclear irradiation of scintillator nanoparticles, that in turn generate UV and visible light that irradiates the photocatalytic nanoparticles of the type described above to generate electron-hole pairs both in the core and the shell of the compoiste (hybrid) nanoparticles. Nuclear waste (e.g. spent fuel) can be employed to irradiate the nanoscintillators, which function as sources of UV and visible light in this embodiment of the invention. Colloidal scintillator nanoparticles and colloidal photocatalytic nanoparticles can be employed in a water co-dispersioin to this end.

This embodiment provides a novel method towards hydrogen production that will use the unique optical and catalytic properties of the photocatalytic nanoparticles with the goal of reducing cost and increasing the overlall efficiency of hydrogen production by irradiation using high-level nuclear waste. This embodiment combines in one system efficient nanoscintillators as sources of UV and visible light emissions, and photactivated nanocatalysts (photocatalytic nanoparticles) for water splitting.

This embodiment may be applied to harvesting the energy of high-level nuclear waste. A rough estimate of 1 kW of power extracted per 1 tonne of spent fuel gives 1,330 kg of H₂ over a period of 10 years. With roughly 3,000 tonnes of waste produced by US nuclear plants per year, there is a clear commercial prospect for nuclear hydrogen production at a level of 4,000 tonnes/year.

According to the above embodiments of the present invention, colloidal scintillator NPs can be used to convert nuclear radiation energy into UV/Vis (visible) light, and to catalyze the water splitting process in a simple process that does not require the use of electrodes. Compared to scintillating particles of the micrometer size, scintillator NPs offer the prospect of significantly improved performance. Due to three-dimensional confinement and much better overlap of electron and hole wavefunctions, the band-to-band optical transitions are much more efficient and faster than in bulk materials. Enhanced light output from nanocrystalline materials, compared to their respective bulk single-crystal or powder forms, has been reported for many NPs.

Enhanced light output translates into higher scintillation efficiency, which is of critical importance for water splitting based on direct irradiation. This embodiment of the present invention allows for the utilization of nanoscintillators in combination with nanophotocatalysts for direct use of nuclear radiation to produce hydrogen, as illustrated in FIGS. 10-11. This embodiment thereby harvests nuclear waste energy and makes this embodiment particularly appealing.

Both nanoscintillator and nanophotocatalyst/co-catalyst materials can be obtained in water-dispersible nanocrystalline form by means of colloidal synthesis. Colloidal nature of both scintillator and photocatalyst particulate systems allows their combination in a single one-pot system for water splitting using the energy of gamma/neutron radiation coming directly from nuclear reactor or from nuclear waste material. Co-dispersed in water, LaF₃:Ce, LaBr₃:Ce/LaF₃, lead-based as well as scintillator NPs with high thermal neutron capture cross sections can be used to convert the energy of gamma/neutron radiation into photons of UV/visible range. Noble metal core/wide-bandgap shell composite photocatalytic NPs co-dispersed in water, enhanced with proper co-catalysts at the colloidal synthesis stage, can serve as photocatalysts to convert photon emission of nanoscintillators into hydrogen.

An important issue in hydrogen production is how to separate hydrogen and oxygen gases. A photo-electrochemical cell offers a simple solution by physically separating the locations at which either gas is generated. An alternative approach, that can be provided by certain embodiments of the present invention, is to disperse nanosized photocatalysts in water. The reduction and oxidation reactions both have to take place at the surface of a single particle, and hydrogen and oxygen, produced in the same reactor volume, need to be separated shortly afterwards. The most attractive materials for hydrogen-permeable membranes are based on palladium, due to their high permeability, high selectivity for H₂, and high thermal/chemical stability.

It is noted that, as used in this specification and the appended claims, the singular forms “a,” “an,” and “the,” include plural referents unless expressly and unequivocally limited to one referent. Thus, for example, reference to “a scintillator” includes two or more different scintillators. As used herein, the term “include” and its grammatical variants are intended to be non-limiting, such that recitation of items in a list is not to the exclusion of other like items that can be substituted or other items that can be added to the listed items.

### Advantages and Benefits of Practice of the Invention

The exponentially growing energy demand is exhausting our fossil fuel supply at an alarming rate [Weisz 2004]. About 13 terawatts (TW) of energy is currently needed to sustain the lifestyle of 6.5 billion people worldwide. By the year 2050, we will need an additional 10 TW of energy to maintain the current lifestyle, according to a very conservative estimate of [Kamat 2007]. To bring the entire globe to the same lifestyle as presently enjoyed by the US, would require 5-fold increase in global energy production based on the data of [Rifkin 2002], increasing 2050 estimate to 115 TW. With the global warming and climate changes from the fossil fuel greenhouse gases becoming a major concern, environmentally clean alternative renewable energy resources are of vital importance. Renewable energy can be tapped from the available resources: hydroelectric power (0.5 TW), from all tides and ocean currents (2 TW), geothermal power integrated over all of the land area (12 TW), globally extractable wind power (2-4 TW), and solar energy reaching the earth (120,000 TW) [Kamat 2007]. Solar energy stands out among these options, as it is by far greater than any of the other renewable sources. Despite this vast resource, the energy produced from solar radiation remains at present at less than 0.01% of the total energy production. New initiatives to harvest incident photons with greater efficiency are in high demand.

Photovoltaic devices with efficiencies between 10 and 20% are currently commercially available. While they are still expensive, their costs are coming down. Like all the other renewable energy sources, solar energy is intermittent and one of the challenges with solar cells is that they can only generate electricity during daytime. Hence, large-scale use of solar energy requires an efficient storage solution. Hydrogen is one very attractive way to store energy to ensure an ongoing and continuing supply of power for society.

Nowadays, 95% of hydrogen is produced from natural gas via a steam-reforming process—a catalytic thermochemical conversion process generating CO₂ as a by-product, which brings into question the claim that hydrogen is an environmentally friendly fuel [Romm 2005]. The most straightforward method to produce hydrogen using water and sunlight is to couple an electrolyzer to a solar cell array. It was shown, however, that for a combined electrolyzer of 85% efficiency with a typical solar cell of 12% efficiency, the overall conversion efficiency is limited to ˜8% [Khaselev 2001]. A potentially much more attractive way is the use of photoelectro-chemical cells.

Photoelectrochemical cells are still in the research stage, and a major drawback of most of the research in this field comes from the fact that appropriate semiconductors are not readily accessible, absorb solar radiation inefficiently, produce hydrogen in a sacrificial way only, or require assistance in the form of an additional external bias. Traditionally, wide-bandgap semiconductors with limited light absorption in the visible (e.g. TiO₂, SrTiO₃) have been used for photoelectrochemical water splitting. Apart from limited light absorption in the visible, current systems for photoelectrochemical water splitting suffer from fast electron-hole recombination and concurrent low efficiencies. Current efficiencies of photoelectrochemical solar light-to-hydrogen conversion (typically ˜1%) lag in general behind the corresponding efficiencies in photovoltaics

For a solar photocatalytic water splitting system based on a single photoconverter, 10-12% process efficiency under AM 1.0 solar irradiation appears to be a reasonable target [Rajeshwar 2007]. This estimate, however, is based on the assumption that we are dealing only with thermalized electrons in semiconductor material, and neglects possible “hot carrier” processes. The invention has a potential to overcome this limitation by dramatically improving the efficiency of the process, and, thus, to revolutionize the field of hydrogen production by photocatalytic water splitting.

By moving closer to practical on-site production of pure and clean H₂ from water using abundant sunlight in a safe, environmentally friendly way, the invention will contribute to reductions of greenhouse gas emission and reductions in imported energy. Breakthroughs will be made possible in the development of small stationary and portable fuel cells, resulting in the fast-growing market for them as mini-plants for use in factories, offices, retail stores, and homes.

In practice of the invention, reactivation of the system should simply involve replenishing of the system with water and may not require a filtration process to separate the catalyst from water, which is known to be inconvenient with powder catalysts.

Although the invention has been described with respect to certain embodiments thereof, those skilled in the art will appreciate that changes and modifications can be made therein within the scope of the appended claims.

### REFERENCES, WHICH ARE INCORPORATED HEREIN BY REFERENCE

[Chuang 2009] H. Y. Chuang and D. H. Chen, “Fabrication and photocatalytic activities in visble and UV light regions of Ag@TiO₂ and NiAg@TiO₂ nanoparticles”, Nanotechnoloy 10, Art. 105704 (10 pp) 2009.
[Dare Edwards 1983] M. P. Dare Edwards, J. B. Gooddenough, A. Hammett, and P. R. Trevellick, Electrochemistry and photoelectrochemistry of iron (III) oxide”, J. Chem.. Soc. Faraday Trans. 79, (Pt. 9) pp. 2027-2041) 1983.
[Du 2009] L. C. Du, A. Furube, K. Yamamoto, K. Hara, R. Katoh, M. Tachiya, “Plasmon-induced charge separation and recombination dynamics in gold-TiO₂ nanoparticle systems: Dependence on TiO₂ particle size”, J. Phys. Chem. C 113 (#16), pp. 6454-6462, 2009.
[Furube 2007] A. Furube, L. Du, K. Hara, R. Katoh, M. Tachiya, “Ultrafast plasmon-induced electron transfer from gold nanodots into TiO₂ nanoparticles”, J. Am. Chem. Soc. 129 (#48), pp. 14852-14853, 2007.
[Hirakawa 2005] T. Hirakawa, P. V. Kamat, “Charge separation and catalytic activity of Ag@TiO₂ core-shell composite clusters under UV-irradiation”, J. Am. Chem. Soc. 127 (#11), pp. 3928-3934, 2005.
[Jakob 2003] M. Jacob, H. Levanon, P. V. Kamat, “Charge distribution between UV-irradiated TiO₂ and gold nanoparticles: Determination of shift in the Fermi level”, Nano Lett. 3 (#3), pp. 353-358, 2003.
[Khaselev 2001] O. Khaselev, A. Bansal, J. A. Turner, “High-efficiency integrated multijunction photovoltaic/electrolysis systems for hydrogen production”, Int. J. Hydrogen Energy 26 (#2), pp. 127-132, 2001.
[Kamat 2007] P. V. Kamat, “Meeting the clean energy demand: Nanostructure architectures for solar energy conversion”, J. Phys. Chem. C 111 (#7), pp. 2834-2860, 2007.
[Langhammer 2006] C. Langhammer, Z. Yuan, I. Zoric, B. Kasemo, “Plasmonic properties of supported Pt and Pd nanostructures”, Nano Lett. 6 (#4), pp. 833-838, 2006.
[Link 1999] S. Link, M. A. El-Sayed, “Spectral properties and relaxation dynamics of surface plasmon electronic oscillations in gold and silver nanodots and nanorods”, J. Phys. Chem. B 103 (#40), pp. 8410-8426, 1999.
[Mavroides 1976] J. G. Mavroides, J. A. Kafalas, and D. F. Kolesar, “Photoelectrolysis of water in cells with SrTiO₃ anodes”, Appl. Phys. Lett. 28 (#5), pp. 241-243, 1 Mar. 1976.
[Rajeshwar 2007] K. Rajeshwar, “Hydrogen generation at irradiated oxide semiconductor-solution interfaces”, J. Appl. Electrochem. 37 (#7), pp. 765-787, 2007.
[Reddy 2007] V. Reddy, A. Currao, and G. Calzaferri. “Gold and silver metal nanoparticle-modified AgCl photocatalyst for water oxidation to O₂”, J. Phys.: Conf. Ser. 61, pp. 960-65, 2007.

### [Rifkin 2002] J. Rifkin, The Hydrogen Economy, Jeremy P. Tarcher/Penguin, New York 2002, p. 49.

[Romm 2005] J. J. Romm, The Hype about Hydrogen, Ch. 4: Hydrogen Production, pp. 67-88, Island Press, Washington 2005.
[Subramanian 2004] V. Subramanian, E. E. Wolf, P. V. Kamat, “Catalysis with TiO₂/gold nanocomposites. Effect of metal particle size on the Fermi level equilibration”, J. Am. Chem. Soc. 126 (#15), pp. 4943-4950, 2004.
[Turkevich 1951] J. Turkevich, P. C. Stevenson, and J. Hillier, “A study of the nucleation and growth processes in the synthesis of colloidal gold”, Discuss. Faraday Soc., 11, 55-75, 1951.
[Weisz 2004] P. B. Weisz, “Basic choices and constraints on long-term energy supplies”, Phys. Today 57 (#7), pp. 47-52, 2004.
[van de Krol 2008] R. van de Krol, Y. Liang, J. Schoonman, “Solar hydrogen production with nanostructured metal oxides”, J. Mater. Chem. 18 (#20), pp. 2311-2320, 2008.

1. A method of producing hydrogen, comprising photocatalytically splitting water using nanoparticles comprising a metal core and semiconductor shell or layer on the core.

2. The method of claim 1 wherein the metal core of the nanoparticles can have different shapes and sizes.

3. The method of claim 1 wherein the metal core comprises a noble metal core or an alloyed noble metal core.

4. The method of claim 3 wherein the noble metal core comprises Ag, Au, Pt, or Pd, or an alloy of those, or an alloy of those with Ni.

5. The method of claim 1 wherein the semiconductor shell or layer is transparent to optical excitation in the visible and near-infrared spectral ranges consistent with the plasmon absorption bands of the metal core.

6. The method of claim 1 wherein the semiconductor shell or layer is selected from the group consisting of TiO₂, ZnS, and Nb₂O₅.

7. The method of claim 1 wherein a co-catalyst is provided on the semiconductor shell or layer.

8. The method of claim 1 wherein the nanoparticles are irradiated with solar radiation.

9. The method of claim 1 wherein the nanoparticles are irradiated with light energy from scintillators irradiated with nuclear radiation.

10. The method of claim 9 wherein the scintillators comprise scintillator nanoparticles.

11. The method of claim 9 wherein the nuclear radiation is provided by generated nuclear waste.

12. The method of claim 9 wherein the nuclear radiation is provided by a nuclear reactor.

13. A water-based dispersion of nanoparticles comprising a metal core and semiconductor shell or layer on the core wherein the nanoparticles can photocatalytically split the water.

14. The dispersion of claim 13 wherein the metal core of the nanoparticles can have different shapes and sizes.

15. The dispersion of claim 13 wherein the metal core comprises a noble metal core or an alloyed noble metal core.

16. The dispersion of claim 15 wherein the noble metal core comprises Ag, Au, Pt, or Pd, or an alloy of those, or an alloy of those with Ni.

17. The dispersion of claim 13 wherein a co-catalyst is provided on the semiconductor shell or layer.

18. The dispersion of claim 13 wherein the semiconductor shell or layer is selected from the group consisting of TiO₂, ZnS, and Nb₂O₅.

19. The dispersion of claim 13 further including scintillator nanoparticles.

20. The dispersion of claim 19 wherein the scintillator nanoparticles are co-dispersed with the photocatalytic nanoparticles.

21. A nanoparticle comprising a metal core and a semiconductor shell or layer on the core for use in photocatalytic splitting of water wherein the shell or layer is transparent to optical excitation in the visible and near-infrared spectral ranges, consistent with the plasmon absorption bands of the metal core.

22. The nanoparticle of claim 21 wherein the metal core can have a shape of sphere, disk, or rod and a dimension in the range of 1 nm to 100 nm.

23. The nanoparticle of claim 21 wherein the metal core comprises a noble metal core or an alloyed noble metal core.

24. The nanoparticle of claim 21 wherein the noble metal core comprises Ag, Au, Pt, or Pd, or an alloy of those, or an alloy of those with Ni.

25. The nanoparticle of claim 21 wherein a co-catalyst is provided on the shell or layer.

26. The nanoparticle of claim 21 wherein the semiconductor shell or layer is selected from the group consisting of TiO₂, ZnS, and Nb₂O₅.
